(19) United States
(12) Patent Application Publication
(10) Pub. No.: US 2002/0007334 A1
(43) Pub. Date: Jan. 17, 2002

(54) Brokerage system and method

(76) Inventors: Vincent Dicks, Colts Neck, NJ (US); Steven Dantus, Chappaqua, NY (US); Richard Lindsey, New York, NY (US); Benneth Egeth, New York, NY (US)

Correspondence Address: Kramer Levin Naftalis & Frankel LLP, 919 Third Avenue, New York, NY, 10022, US

(21) Appl. No.: 09/785,076

(22) Filed: Feb. 16, 2001

Related U.S. Application Data
(60) Provisional application No. 60/183,600, filed on Feb. 18, 2000.

(51) Int. Cl. G06F 17/60

(52) U.S. Cl. 705/37

(57) ABSTRACT

A system and method allowing online or traditional business entities, organizations, affinity groups or the like to offer brokerage services to their pre-existing customer or member base. Such entities can thereby leverage their pre-existing good will in one area (e.g., as a popular web portal) into the brokerage business. In accordance with the present invention, such entities provide a front-end brokerage interface to their constituents while all other brokerage functions are carried out by a brokerage entity which performs the functions of a clearing broker and some of the functions of an introducing broker not otherwise provided by the front-end interface. In an exemplary embodiment of the present invention, a non-brokerage party such as a web portal provides news and quotes for a variety of financial instruments, such as stocks. A user of the site is given the ability to trade a stock by clicking on a “trade” link. Upon so clicking, the user is directed to the servers of a brokerage firm which then carries out the rest of the transaction. Any user-identifying information can be provided by the portal, although additional information may be requested for security purposes by the brokerage server. Preferably, the linkage between the front-end and the brokerage party appears as seamless as possible to the user.

### RELATED CASES

The present application is based on and claims priority from U.S. Provisional Patent Application No. 60/183,600, filed Feb. 18, 2000 and incorporated by reference herein in its entirety.

### FIELD OF THE INVENTION

The present invention relates to systems and methods for providing brokerage services, particularly brokerage services related to the financial markets.

### BACKGROUND INFORMATION

Typically, several different parties, oragnizations or entities may be involved in the consumer brokerage business. For example, a correspondence or introducing broker performs “front office functions,” interacting directly with customers. The introducing broker typically takes orders from customers and determines whether each order is allowable and/or appropriate (e.g. whether the customer is cleared to trade a particular instrument or has sufficient available funds for a transaction, etc.) The introducing broker may also offer financial or other advice, and added services (e.g., portfolio summaries, stock or bond ratings or reports, or financial news or analises).

A further party, the clearing broker performs what are typically referred to as “back office functions.” This includes “carrying” the various customer accounts of multiple correspondence brokers. Carrying accounts includes maintaning records as well as actual custody of the assets in the account. The clearing broker also manages and transmits trade confirmation notices and account statements, processes trades, and settles trades. Typically, the correspondence broker executes trades, but this function may also be performed by the clearing broker.

It may be desirable for entities that have not historically performed correspondence brokerage functions, including organizations which until recently had not existed, to act as correspondence brokers. Organizations such as department stores, Internet Web portals, or affinity groups lacking experience and a reputation in the brokerage industry, may wish to participate in the brokerage industry without a large outlay of capital and effort. Such organizations may wish to provide brokerage services to their customers without having to create a brokerage organization, develop the expertise to perform brokerage operations, and, possibly, comply with various regulatory standards.

Web portal sites (e.g., Yahoo or Go.com) are the entry points to the Internet for many users. Much of the revenue of portal sites comes from selling advertising space to companies hoping to gain access to the large number of users accessing the portals' search engines and proprietary and other content. Portals also earn money directly from their users by, for example, offering premium services to their users or by receiving commissions for products or services sold by third parties through the portal site. Some portals receive advertising revenue from correspondence brokers such as on-line brokers, and may refer users to correspondence brokers by, for example, including links to correspondence brokers on their Web sites.

A brokerage business may have to devote a large amount of resources to starting a web business, including gaining the requisite expertise and modifying their site. On the other hand, web portal sites can substantially augment their profitability by acting as correspondence brokers as opposed to simply advertizing for or referring customers to other entities offering such services.

A natural shortcoming non-brokerage, web-based entities may face in entering the brokerage business is their lack of credibility in that area. Despite this, such organizations typically have structures and systems which could form part of any on-line brokerage service, such as payment and customer tracking systems and financial information sources and web pages. In addition, certain portals offer securities and financial information, which may be tailored to individuals; for example, Yahoo provides a portfolio tracking feature to users. Further incentives result from the additional traffic which would result from offering brokerage services via the organization's site, as increased traffic increases advertisement revenue.

Other online entities, such as e-commerce sites selling goods and services over the Internet (e.g., Amazon.com) are broadening their range of goods and services offered. Such organizations may also profit from providing correspondence brokerage functions on their site but may similarly lack the expertise and capital to build a correspondence brokerage business from scratch.

An organization that includes a pre-existing brokerage business could benefit from access to the millions of visitors to portal Web sites or the like. There are reasons not to do so by traditional methods, such as advertizing or referrals. Advertising brokerage services on a Web site involves paying the Web site revenue, instead of collecting revenue, and requires that the advertiser offer a brand name and infrastructure to customers. An organization offering brokerage services may not have or wish to develop a recognizable brand name for such front end, client based services to the general consumer population; such a brand name would be required for the advertising or referral model. It may cost on the order of $100 million annually in advertising budgets to create and maintain a brand name for such services.

Further, an organization which already provides such correspondence brokerage services through other channels, such as offices, store fronts, or other traditional methods, may not wish to create a front end brokerage service on the Internet which would compete with, interfere with, or possibly tarnish its traditional brokerage services. The Internet side of the brokerage business has developed as a “low end”, discout brokerage business; such an image may be incompatible with the existing “high end”, full service brokerage business of an organization which otherwise wishes to participate in the Internet brokerage market. The organization's existing traditional brokerage business may be threatened with the competition offered by that same organization's Internet-based brokerage business. Despite the negative impact on such an organization from participation in discount brokerage activities, there is increasing activity in this area, such that it may be profitable and even necessary for brokerage organizations to enter the discount area.

### SUMMARY OF THE INVENTION

The present invention solves the aforementioned problems by allowing online or traditional business entities, organizations, affinity groups or the like to offer brokerage services to their pre-existing customer or member base. Such entities can thereby leverage their pre-existing good will in one area (e.g., as a popular web portal) into the brokerage business. In accordance with the present invention, such entities provide a front-end brokerage interface to their constituents while all other brokerage functions are carried out by a brokerage entity which performs the functions of a clearing broker and some of the functions of an introducing broker not otherwise provided by the front-end interface.

In an exemplary embodiment of the present invention, a web portal provides news and quotes for a variety of financial instruments, such as stocks. A user of the site is given the ability to trade a stock by clicking on a “trade” link. Upon so clicking, the user is directed to the servers of a brokerage firm which then carries out the rest of the transaction. Any user identifying information can be provided by the portal, although additional information may be requested for security purposes by the brokerage server. Preferably, the linkage between the front-end, provided by the non-brokerage party, and the “back-end,” provided by the brokerage party, appears as seamless as possible to the user.

### BRIEF DESCRIPTION OF THE DRAWINGS

FIG. 1 is a schematic block diagram of a network over which an embodiment of the present invention has been implemented.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well known features may be omitted from or simplified in the specification in order not to obscure the present invention.

In an exemplary embodiment of the system and method of the present invention, a non-broker, such as an entity or an organization that does not act as or maintain an infrastructure for brokerage services, may act as and be perceived as acting as a correspondence or introducing broker. The non-broker may interact with brokerage customers, take orders, offer financial information, and send bills and statements to customers. The substantive brokerage functions, including some traditionally performed by a correspondence brokerage and typically all of those functions performed by a clearing brokerage are performed by a broker party. A “broker party” is used herein to connote a party which has the expertise, infrastructure, and, if required, regulatory permission to provide brokerage services.

In an exemplary embodiment, the broker party provides the non-broker party with brokerage software, such as software operating on a Web server, to maintain a web page which is labeled with the non-brokers name and/or Trademark information, but which is operated by and linked to the broker party. The brokerage software takes securities trade orders and, since it is tied to the broker party, those orders may be executed and cleared through traditional methods, such methods being performed by the broker party. Customer account information is maintained by the broker party.

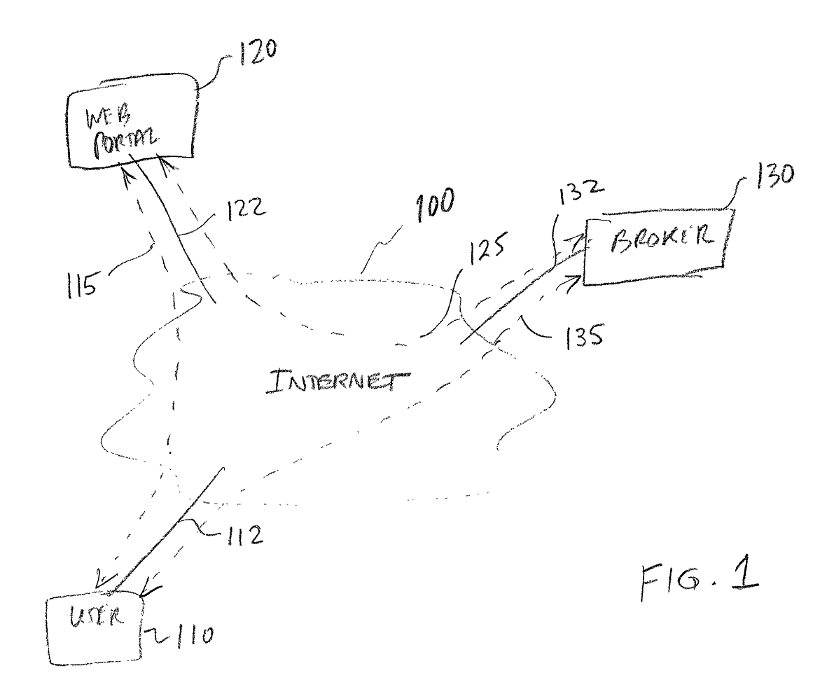

In an exemplary embodiment, as shown in FIG. 1, the non-broker party 120 is a Web-based organization such as a Web portal site or a Web-based retailer or affinity organization (e.g., Yahoo.com, Amazon.com, or a Web site devoted to a union or university). In alternate embodiments, the non-broker party may be another organization, such as a department store or non-Web based affinity organization. In the case that the non-broker party is Web-based, the broker party maintains a server 130 that is accessible from the non-broker party Web site, preferably through known methods such as a hyperlink. The broker server 130 maintains a web site that preferably appears as an extension or part of the non-broker party Web site. In other words, a user 110 accessing the broker web site via a link from the non-broker party 120, preferably will feel as though he is still dealing with the non-broker party 120. The sites maintained by the non-broker 120 and broker 130 preferably have a similar look and feel and use the trademarks or other identifying markings of the non-brokerage party. To support multiple non-broker entities 120, the broker server 130 may have to support several different websites so as to be compatible with each non-broker entity. (In an alternative, one or more standardized appearances can be used by the broker server 130.) In such a manner, the broker party essentially provides a “private label” brokerage service which bears the label or mark of the non-broker party.

For example, a user 110 accessing the non-broker Web site 120 may sign in using a user ID and password, and may navigate to a section of the site devoted to financial information, and to the user's financial information in particular. The user may be presented with options to view financial information, for example stock quotes or ratings or advice regarding various securities. The user 110 may be presented with a button or hyperlink which allows access to brokerage services, and which is so labeled. If the user presses the button, a hyperlink causes a broker Web site 130 maintained by the broker party (but preferably labeled with the name and/or mark of the non-broker party) to be displayed. The broker Web site allows the user to trade securities using an account identified with the user and maintained by the broker party.

To the user 110, the non-broker party 120 appears as the provider of the brokerage services. Thus, the non-broker party may use its name, goodwill, and access to and familiarty with users to market brokerage services as though provided by the non-broker party. The non-broker party does not have to invest in the infrastructure for or significantly alter its Web site for the new service. The broker party and non-broker party may share the fees or profits from the brokerage service in various ways; in any case, advantage is conferred on both parties. The non-broker party also benefits from the increased functionality of its site, resulting in increased traffic and increased advertising revenues.

The broker party benefits in that it gains a new market for its brokerage services via the large numbers of users accessing the non-broker party site, and using the non-broker party name and marketing efforts, without certain costs and detriments. The broker party is spared marketing costs and negative impact on its existing brokerage services. In fact, if the broker party concentrates on “high end” brokerage services, cooperating with a Web portal on brokerage services may be a hedge against brokerage activity moving from high-end services to lower-end internet trading. The resulting Web brokerage business is akin to another large clearing client of the broker party.

Since, increasingly, corporations issuing stock wish to see a portion of the issuance to be directed towards the Internet brokerage market, a broker party using the system and method of the present invention is more likely to participate in such stock issues.

In an exemplary embodiment, the brokerage party sets up a web site under the non-brokerage party's name. A customer comes to the web site and enters his user identification and password to then enter a brokerage page where they can access information about their accounts. They have access to certain calculators, content, research, etc. Furthermore, the brokerage party may also provide live customer service services, such as via telephonic links. For multiple non-brokerage parties, each can be associated with a different incoming telephone number. The service representatives can answer each line accordingly as though they were answering it on behalf of the non-brokerage entity. The brokerage party may also provide compliance officers, accounting reporting functions, etc.; “front-end” functions traditionally performed by correspondent brokers.

The present invention is not limited to an internet portal or to any web-based entity. The non-brokerage party can be any association or group which until now could not provide brokerage services, or it could be a traditional retailer, etc.; any entity with a group of captive people that could use brokerage services, particularly discount brokerage services. It is logical to implement the present invention with a web portal since their “members” are already on the internet and providing brokerage services to them is just a click away.

While the system of the present invention is described with respect to specific embodiments, it should be noted that the present invention may be implemented in different manners and used with different applications.

What is claimed is:

1. A method of providing brokerage services to a customer, the method comprising:
providing a communications link between a non-broker party and a customer;
providing a communications link between the non-broker party and a broker party; and
performing a brokerage service by the broker party in response to communications between the customer and the non-broker party.

2. The method of claim 1, wherein the step of performing a brokerage service includes establishing a communications link between the broker party and the customer.

3. The method of claim 1, wherein the communications links are provided over the Internet.

4. A method of providing brokerage services to a customer, the method comprising:
a non-broker party providing an interface to a user, the interface including a brokerage services interface, both the interface and the brokerage services interface being branded with a mark of the non-broker party;
the non-broker party exchanging communications with a customer;
the non-broker party transmitting certain of said communications to a broker party;
the broker party performing a brokerage service for the non-broker party.

5. The method of claim 4, wherein the step of performing a brokerage service includes establishing communications between the broker party and the customer.

6. The method of claim 4, wherein the communications are provided over the Internet.
